(19) United States
(12) Patent Application Publication
(10) Pub. No.: US 2022/0016650 A1
(43) Pub. Date: Jan. 20, 2022

(54) ELECTROSTATIC SPRAY TECHNIQUES FOR FLUID DISPERSION

(71) Applicant: IsoKlean LLC, Norcross, GA (US)

(72) Inventor: Jerry Smith, Littleton, CO (US)

(73) Assignee: IsoKlean LLC, Norcross, GA (US)

(21) Appl. No.: 17/372,861

(22) Filed: Jul. 12, 2021

Related U.S. Application Data
(60) Provisional application No. 63/051,463, filed on Jul. 14, 2020.

(51) Int. Cl. B05B 5/053; B05B 5/00; B05B 5/16

(52) U.S. Cl. CPC B05B 5/0533; B05B 5/1691; B05B 5/006

(57) ABSTRACT

An electrostatic spray device includes an electrostatic mixing chamber and an electrode pair in the electrostatic mixing chamber. The electrostatic mixing chamber receives an airflow that is driven by a fan of the electrostatic spray device. The electrostatic mixing chamber also receives a flow of fluid from a reservoir of the electrostatic spray device. The electrode pair is configured to apply electrostatic charge to droplets of the fluid suspended in the airflow. A voltage level of the electrostatic charge is adjustable responsive to a first DC output from a first DC convertor. A flow volume of the fluid from the reservoir is adjustable responsive to a second DC output from a second DC convertor. In some cases, a control unit of the electrostatic mixing device modifies the first or second DC outputs based on a target level of the voltage level or the flow volume.

### RELATED APPLICATIONS

The present application claims priority to U.S. provisional application No. 63/051,463 for “Electrostatic spray techniques for fluid dispersion” filed Jul. 14, 2020, which is incorporated by reference herein in its entirety.

### TECHNICAL FIELD

This disclosure relates generally to the field of fluid spray techniques, and more specifically relates to electrostatic spray techniques.

### BACKGROUND

An electrostatic spray device may be used to disperse a fluid, such as a cleaning solution or a disinfectant. The fluid may be dispersed by the electrostatic spray device onto equipment, a floor, a countertop, fabric, or other surface. An electrostatic charge may be provided to the fluid, which will cause the fluid to adhere to many surfaces onto which it is sprayed. In some cases, consistent dispersion of the fluid may provide a beneficial effect, such as improving disinfection of the surface receiving the fluid or increasing efficiency of a person applying the fluid. It may be desirable for the electrostatic spray device to include features that are capable of dispersing a consistent amount of fluid. In addition, it may be desirable for the electrostatic spray device to include features that are capable of efficiently dispensing a consistent amount of fluid.

### SUMMARY

According to certain embodiments, an electrostatic spray device includes a fan, a motor, a first direct current (“DC”) convertor having a first adjustable DC output, a second DC convertor having a second adjustable DC output, an electrostatic mixing chamber, and an electrode pair that is included in the electrostatic mixing chamber. The motor is configured to drive the fan. The electrostatic mixing chamber is configured to receive an airflow from the fan. The electrostatic mixing chamber is also configured to receive a flow of fluid from a reservoir. The electrode pair is configured to apply an electrostatic charge to droplets of the fluid that are suspended in the airflow. A voltage level of the electrostatic charge is adjustable responsive to a first modification of the first adjustable DC output. A flow volume of the flow of fluid from the reservoir is adjustable responsive to a second modification of the second adjustable DC output.

According to some embodiments, an electrostatic mixing chamber includes an electrode pair. The electrode pair is configured to apply an electrostatic charge to droplets of fluid that are suspended in an airflow received by the electrostatic mixing chamber. A voltage level of the electrostatic charge is adjustable based on a first adjustable DC output. A flow volume of the fluid from is adjustable based on a second adjustable DC output.

According to some embodiments, a control unit included in an electrostatic spray device is configured to generate a first control signal. The first control signal is for a first DC convertor having a first adjustable DC output. Via the first control signal, a voltage of an electrode pair included in the electrostatic spray device is modified. The electrode pair is configured to apply an electrostatic charge to droplets of fluid that are suspended in an airflow of the electrostatic spray device. The control unit is further configured to generate a second control signal. The second control signal is for a second DC convertor having a second adjustable DC output. Via the second control signal, a flow volume of a flow of fluid from a reservoir of the electrostatic spray device is modified.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of an electrostatic spray device, according to certain aspects described herein;

FIG. 2 is a diagram depicting an example of a mixing unit included in an electrostatic spray device, according to certain aspects described herein;

FIG. 3 is a diagram depicting an example configuration of electrical components included in a mixing unit of an electrostatic spray device, according to certain aspects described herein; and

FIG. 4 is a diagram depicting an example region of a pickup tube that includes an extended ionization film, according to certain aspects described herein.

### DETAILED DESCRIPTION

Contemporary electrostatic spraying techniques may lack features for consistent or efficient application of fluid onto a surface. In addition, contemporary electrostatic spraying techniques may be unable to adjust characteristics of the spray, such as an electrostatic charge or an airspeed of the fluid being sprayed.

An improved electrostatic spray device may include one or more features to improve efficiency or consistency for application of a fluid. For example, an improved electrostatic spray device may include one or more features to provide adjustable output flow of fluid droplets suspended in an airflow, adjustable electrostatic charge to output droplets, adjustable distance of output application, efficient application of fluid, efficient use of fluid, ozonation of an output fluid, ionization of an output fluid, or additional features or combinations of features, as described herein.

In some cases, a fluid that is being sprayed may include a liquid, a solid, or a gas. For convenience, and not by way of limitation, techniques described herein are described in regards to a liquid fluid, but other implementations are possible. For example, the described techniques may be used to disperse an electrostatic spray of a liquid (e.g., water, oil, alcohol, chemical solutions), a solid (e.g., powder, sand), a gas, a mixture of multiple components (e.g., an alcohol-water mixture, a suspension of a solid powder in water), or any other suitable fluid or combination of fluids. In some implementations, a fluid that is being sprayed may include a cleaning fluid, a disinfectant, a paint, a deodorizing fluid, a perfume, an entertainment product (e.g., colorful powder, artificial fog), or any other fluid that is suitable to be sprayed.

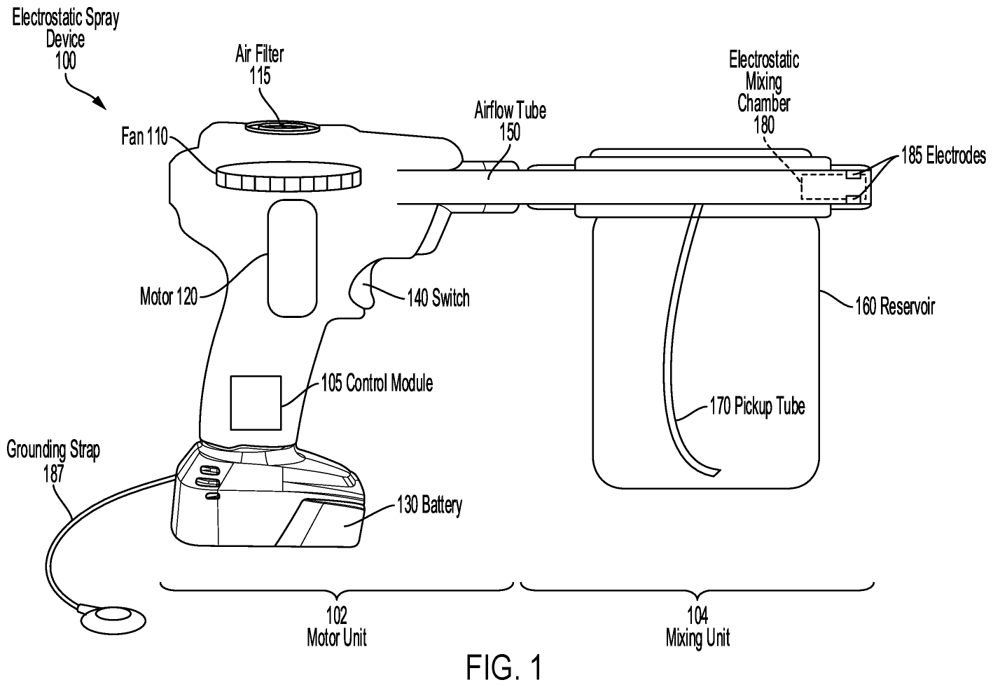

Referring now to the drawings, FIG. 1 is a diagram depicting an example electrostatic spray device 100. The electrostatic spray device 100 may include one or more sub-components, such as a motor unit 102 or a mixing unit 104. The motor unit 102 may include, for example, one or more of a motor 120, a fan 110, a control module 105, a switch 140, a battery 130, or an air filter 115. In addition, the mixing unit may include one or more of a reservoir 160, a pickup tube 170, an electrostatic mixing chamber 180, or electrodes 185. In some implementations, the motor unit 102 and the mixing unit 104 are configured to connect together, such that air may be directed from the motor unit 102 into the mixing unit 104, such as via an airflow tube 150.

In some implementations, the motor 120 can be configured to drive the fan 110 such that airflow generated by the fan 110 is directed into the airflow tube 150. In addition, airflow in the airflow tube 150 may be directed towards the electrostatic mixing chamber 180. The electrostatic mixing chamber 180 may receive fluid from the reservoir 160, such as fluid that is transported via the pickup tube 170. In the electrostatic mixing chamber 180, one or more of the electrodes 185 may apply an electrostatic charge to the fluid received from the reservoir 160. In some cases, one or more of the electrodes 185 may modify chemical characteristics of the fluid, such as modifying a quantity of ions in the fluid (e.g., via electrochemical ionization), modifying an ozone concentration in the fluid (e.g., via ozonation), or another suitable chemical characteristic of the fluid. Responsive to receiving the electrostatic charge, the fluid may separate into droplets, such as charged droplets. In addition, the droplets may be combined with the airflow that is in the airflow tube 150. The electrostatic spray device 100 may disperse an output flow that includes charged droplets that are suspended in the airflow. In some cases, the charge applied to the droplets may encourage the droplets to increase a distance between each charged droplet during dispersal. In addition, the charged droplets may disperse in a consistent pattern that is based on a level of the charge that is applied to the droplets. For example, droplets that have a higher charge (e.g., a larger absolute value of electrostatic charge) may tend to disperse in a wider pattern as compared to droplets that have a lower charge (e.g., a smaller absolute value of electrostatic charge).

In some cases, the electrostatic spray device 100 may include a grounding strap 187, such as a grounding strap that may be worn by (or connected to a wearable item for) a person using the electrostatic spray device 100. The grounding strap 187 may include a first electrical connection to a circuit that includes the electrodes 185, such as a DC convertor that supplies power to the electrodes 185. In addition, the grounding strap 187 may include a second electrical connection that is configured to connect with a personal grounding interface. The personal grounding interface could be a wrist strap, an ankle strap, an adhesive conductor (e.g., wearable electrodes), or other grounding interfaces that are suitable to be worn by a person. For example, the grounding strap 187 may include a metal connector, such as a snap or clip, that can form an electrical connection with a personal grounding interface, such as a wrist strap worn by a user of the electrostatic spray device 100. In some cases, the grounding strap 187 can be configured to include a person in a ground circuit of the electrodes 185, or additional components of the electrostatic spray device 100. For instance, including the example user of the electrostatic spray device 100 in the ground circuit of the electrodes 185 can reduce electrostatic attraction of charged droplets to the user. In addition, reducing electrostatic attraction of charged droplets to the user can increase adhesion of charged droplets to a surface that is treated via the electrostatic spray device 100.

In the electrostatic spray device 100, the motor 120 may be configured to operate based on direct current (“DC”) or alternating current (“AC”). In some cases, the motor 120 may include (without limitation) a DC motor (such as a brushless DC motor or a brushed DC motor), an AC motor, or any other suitable type of motor (or combination of motors) that is suitable to drive the fan 110. In some cases, the electrostatic spray device 100 may have an improved efficiency based on a type of the motor 120. For example, the electrostatic spray device 100 may have an improved efficiency (e.g., efficient use of power, efficient fluid dispersion in a period of time) in an implementation where the motor 120 is a DC brushless motor.

In addition, the fan 110 may include (without limitation) an axial fan, a centrifugal fan, a mixed-flow fan, a piezoelectric fan, or any other type of air movement device (or combination of devices) that is suitable to generate airflow within the electrostatic spray device 100. In some cases, the electrostatic spray device 100 may include one or more air filters, such as the air filter 115. The air filter 115 may be configured to filter air that is received by the fan 110. In some cases, the electrostatic spray device 100 may provide an output flow with improved air quality as compared to a spray device that does not include an air filter. For example, airflow in the airflow tube 150 may have a higher air quality (e.g., reduced particulate content, reduced microbial content, reduced chemical content) in an implementation where the airflow is generated based on air that has passed through the air filter 115. A non-limiting example of the air filter 115 may include a high-efficiency particular air (“HEPA”) filter, or another suitable type of air filter. In some implementations, the air filter 115 may have a rating that indicates a size or type of particle that may be filtered, such as (without limitation) a minimum efficiency reporting values (“MERV”) rating. In some cases, an electrostatic spray device that includes an air filter with a relatively high rating (e.g., indicating a high efficiency of particulate entrapment) may provide an output flow with improved air quality as compared to a spray device that does not include an air filter. For example, if the air filter 115 is a HEPA filter having a MERV rating of 16, the air filter 115 may remove at least 99.97% of airborne particulate (e.g., dust, smoke, microbes) having a size of 0.3 μm.

In some implementations, the electrostatic spray device 100 may include one or more of the switch 140 or the control module 105. In some cases, activity of the motor 120, the electrodes 185, or another suitable component of the electrostatic spray device 100 may be modified via a control signal that is generated by one or more of the switch 140 or the control module 105. For example, a speed of the motor 120 could be modified based on the example control signal. In addition, a voltage of one or more of the electrodes 185 could be modified based on the example control signal. In some cases, one or more control signals to the motor 120 or the electrodes 185 (or other suitable component) are generated automatically, such as by the control module 105. For example, the control module 105 may determine a target level for one or more of a voltage level of the electrodes 185 (e.g., for a level of the electrostatic charge), a flow volume of fluid from the reservoir 160, or an airflow velocity from the fan 110. Responsive to determining the target level, the control module 105 may adjust one or more of the voltage level, flow volume, or airflow velocity, such as by providing a control signal to one or more components of the electrostatic spray device (e.g., the motor 120, a DC convertor for the electrodes 185, a DC convertor for an air pump of the reservoir 160).

In addition, one or more control signals to the motor 120 or the electrodes 185 (or other suitable component) may be generated based on an input received by one or more of the switch 140 or control module 105. For example, a user of the electrostatic spray device 100 may provide an input to the switch 140, such as by applying pressure to the switch 140. In addition, the example user may provide an input to the control module 105, such as by transmitting a signal to the control module 105 via an input control (e.g., a button, a dial), an antenna (e.g., Wi-Fi, Bluetooth), or any other suitable wired or wireless transmission technique. In some cases, activity of the motor 120, such as motor speed, may be modified based on an input to the switch 140, and activity of one or more of the electrodes 185, such as voltage, may be modified based on an additional input to the control module 105. As a non-limiting example, the switch 140 may include a pulse width modulation (“PWM”) switch. For example, the PWM switch may be coupled to the motor 120, such that activity of the motor 120 may be modified based on an input to the PWM switch.

In some implementations, a dispersal of the output flow from the electrostatic spray device 100 may be modified based on inputs to one or more of the switch 140 or control module 105. For example, based on an input to the switch 140, a speed of the motor 120 may be modified. Responsive to the modification of the motor speed, a velocity of airflow in the airflow tube 150 may be modified (e.g., a speed of the fan 110 increases or decreases). In addition, a dispersal distance of the output flow (e.g., distance from an output of the airflow tube 150) may be modified responsive to the modification of the motor speed. For example, the output flow may increase in dispersal distance based on an increase in motor speed. In addition, the output flow may decrease in dispersal distance based on a decrease in motor speed. As an additional example, based on an additional input to the control module 105, a voltage of one or more of the electrodes 185 may be modified. Responsive to the modification of the voltage, charge applied to the fluid droplets via the electrodes 185 may be modified. In addition, a pattern of the output flow (e.g., a distance between charged droplets) may be modified responsive to the modification of the voltage. For example, the output flow may increase an application area (e.g., increased distance between charged droplets) based on an increase in voltage. In addition, the output flow may decrease an application area (e.g., decreased distance between charged droplets) based on a decrease in voltage. In some cases, the electrostatic spray device 100 may provide output flow with improved efficiency, as compared to a spray device that lacks one or more of adjustable airflow velocity or adjustable electrostatic charge. For example, the electrostatic spray device 100 may have reduced disruptions (e.g., clogging) to the output flow based on an adjustable airflow velocity, such as by allowing reduced velocity for an output flow with larger droplet size. In addition, the electrostatic spray device 100 may provide more consistent application of the output flow to surfaces based on an adjustable electrostatic charge, such as by allowing increased (or decreased) droplet charge when spraying surfaces with lower (or higher) electrostatic characteristics. As a non-limiting example, droplets with a higher charge may have a higher electrostatic attraction to metal as compared to wood, or may have higher electrostatic attraction to surfaces in dry air as compared to humid air.

In some cases, the electrostatic spray device 100 may include one or more indicators that are configured to indicate characteristics of the output flow or activity of the electrostatic spray device 100. The indicators may include one or more of a visual indicator, audible indicator, an indicator signal that may be provided to an additional device (e.g., a remote control panel, a personal digital device), or any other suitable type of indicator. For example, the electrostatic spray device 100 may include a neon lighting element that is configured to indicate a presence or intensity of charge applied by the electrodes 185. In addition, the electrostatic spray device 100 may include an additional indicator that is configured to indicate a dispersal pattern or dispersal distance of the output flow from the device 100. In some cases, the example indicator may include (without limitation) one or more of a neon bulb, a light-emitting diode, an incandescent bulb, a speaker (e.g., audible alert), a haptic component (e.g., vibration alert element), a wired transmission signal, a wireless transmission signal, or any other suitable indicator type.

The electrostatic spray device 100 may include one or more power sources, such as the battery 130, that are capable of providing power to one or more of the motor 120, the control module 105, the switch 140, the electrodes 185, or any other suitable component of the electrostatic spray device 100. As described in regards to FIG. 1, the battery 130 may provide DC power to one or more components of the electrostatic spray device 100. However, other implementations are possible. For example, an electrostatic spray device may be a corded device, such as a corded electrostatic spray device that is designed to plug into a power outlet. The example corded electrostatic spray device may include a transformer that is capable of converting AC power to DC power, such as an AC-to-DC transformer. In addition, the example corded electrostatic spray device may be configured to provide AC power to one or more components of the electrostatic spray device (e.g., an AC motor).

In some implementations, one or more of the airflow tube 150 or the electrostatic mixing chamber 180 may receive fluid from the reservoir 160. For example, the pickup tube 170 may receive fluid that is contained within the reservoir 160. In addition, the pickup tube 170 may provide the fluid to, for example, the electrostatic mixing chamber 180. In some implementations, the electrostatic spray device 100 may include one or more components configured to modify a volume of fluid received from the reservoir 160. For example, the electrostatic spray device 100 may include an air pump that is configured to adjust an air pressure within the reservoir 160. Responsive to an adjustment of the air pressure within the reservoir 160, the pickup tube 170 may transport an increased volume of liquid (e.g., based on an increase in the air pressure) or a decreased volume of liquid (e.g., based on a decrease in the air pressure) to the airflow tube 150 or the electrostatic mixing chamber 180.

In some cases, the airflow tube 150 may be included in one or more of the motor unit 102 or the mixing unit 104. In addition, the airflow tube 150 may comprise one or more portions, such as a portion is included in the motor unit 102 and an additional portion included in the mixing unit 104. The example portions may be configured to connect together, such that the connected portions form the airflow tube 150 extending from the motor unit 102 through the mixing unit 104. FIG. 1 depicts the airflow tube 150 as having consistent dimensions of length and width, but other implementations are possible. For example, the electrostatic spray device 100 may include an airflow tube that has a tapered region, such as one or more interior surfaces that have a wider dimension (e.g., at an inlet) and a narrower dimension (e.g., at an outlet). In some cases, an airflow tube with a tapered region may modify a velocity of airflow within the airflow tube. For example, airflow velocity may be increased in a tapered region that has a wider dimension at an inlet and a narrower dimension at an outlet.

FIG. 1 depicts the electrostatic mixing chamber 180 as a region that is included in the airflow tube 150, but other implementations are possible. For example, an electrostatic spray device could include an electrostatic mixing chamber that is connected to an airflow tube, such that airflow in the tube passes into the connected electrostatic mixing chamber.

In some implementations, the electrostatic spray device 100 may be a hand-held device. For example, the motor unit 102 is depicted as including a handle area, such as an area between the battery 130 and the switch 140. However, additional implementations are possible. For example, an electrostatic spray device having one or more of the features described herein may be operable as a non-hand-held device. The example electrostatic spray device could be configured to attach to an extension unit, such as an extension unit that is capable of reaching distant surfaces (e.g., ceilings, high shelves). In addition, the example electrostatic spray device could be configured as a remote device, such as an automated or remote-controlled device (e.g., wheeled robot, drone) that is capable of dispersing the output flow in areas where a human is not located. In some implementations, the example electrostatic spray device could include (or be configured to connect to) one or more connections to external resources. For example, the connections could include an electrical power cord configured to connect to a power outlet. In addition, the connections could include an air supply tube configured to connect to an air supply that is remotely located from the electrostatic spray device. In some cases, an electrostatic spray device that is configured to connect to a remote air supply may provide improved air quality (e.g., reduced particulate content, reduced microbial content) as compared to a spray device that intakes local air from the area being treated by the spray device.

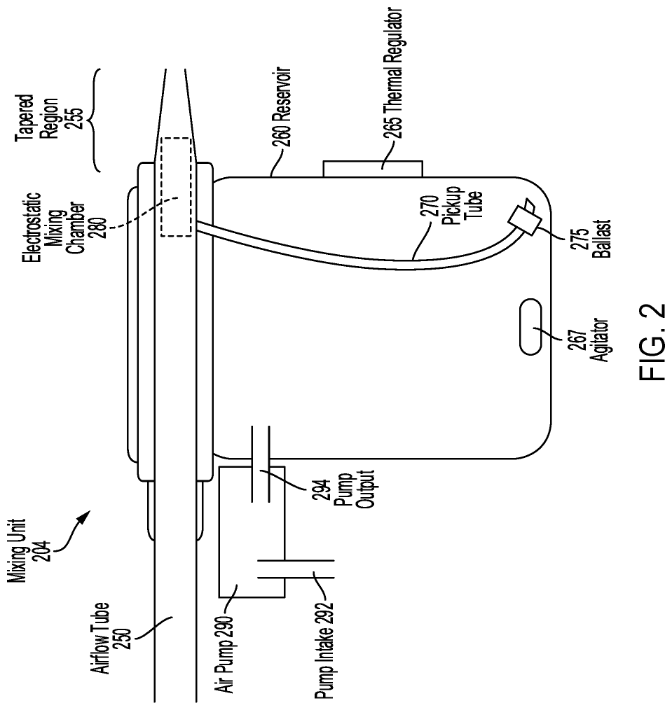

In some implementations, an electrostatic spray device may include a mixing unit having one or more features that are capable of improving a consistency of output flow from the electrostatic spray device. FIG. 2 is a diagram depicting an example of a mixing unit 204 that may be included in an electrostatic spray device, such as the electrostatic spray device 100. For example, the mixing unit 204 may be attached to the motor unit 102, such as described in regards to FIG. 1. FIG. 2 depicts a side view of a possible configuration of the mixing unit 204, but other configurations are possible. The mixing unit 204 may include an airflow tube 250. In addition, the airflow tube 250 may be configured to connect to a motor unit (e.g., the motor unit 102) such that airflow generated by a fan in the motor unit is directed into the airflow tube 250. In some implementations, the airflow tube 250 includes one or more tapered regions, such as a tapered region 255. The tapered region 255 may have one or more interior surfaces (e.g., interior surfaces of the airflow tube 250) that have a wider dimension at an inlet and a narrower dimension at an outlet. For example, the tapered region 255 may receive airflow at the wider inlet and expel airflow at the narrower outlet. In some cases, the tapered region 255 may modify a velocity of airflow within the airflow tube 250. For example, the velocity of the airflow in the airflow tube 250 may increase while the airflow is in the tapered region 255. In addition, fluid droplets that are suspended in the airflow may also increase in velocity in the tapered region 255. For instance, the mixing unit 204 may utilize some aspects of the Venturi effect to provide an increased velocity of airflow and/or suspended droplets. In some cases, an electrostatic spray device that includes the mixing unit 204 with the tapered region 255 may provide an output flow with improved efficiency compared to a spray device that lacks a tapered airflow tube. For example, the example electrostatic spray device with the tapered region 255 may provide an output flow at higher velocity, allowing a user of the electrostatic spray device to apply the output flow more quickly. In addition, the example electrostatic spray device with the tapered region 255 may have reduced disruptions (e.g., sputtering, output vacation) to the output flow, allowing a user of the electrostatic spray device to apply the output flow more consistently, with fewer interruptions.

In some implementations, the mixing unit 204 may include one or more of a reservoir 260, a pickup tube 270, or an electrostatic mixing chamber 280 (e.g., such as described in regards to FIG. 1). The electrostatic mixing chamber 280 may include one or more electrodes configured to apply an electric charge to droplets of fluid suspended in the airflow. In some cases, the tapered region 255 may include some or all of the electrostatic mixing chamber 280. For example, the tapered region 255 may include at least one pair of electrodes of the chamber 280, such that electric charge is applied to droplets within the tapered region 255.

In the mixing unit 204, the pickup tube 270 may provide fluid from the reservoir 260 to one or more of the airflow tube 250 or the electrostatic mixing chamber 280. The pickup tube 270 may have an outlet (e.g., to expel fluid) that is located within the tapered region 255. In some cases, a volume of fluid provided by the pickup tube 270 may be modified based on airflow velocity within the tapered region 255. For example, an increased airflow velocity may reduce air pressure on the fluid at the outlet of the pickup tube 270. Responsive to the reduced air pressure at the outlet, an increased volume of fluid may be expelled by the pickup tube 270. For instance, the mixing unit 204 may utilize some aspects of Bernoulli's principle to provide an increased volume of fluid from the pickup tube 270. In some cases, an electrostatic spray device that has an outlet of the pickup tube 270 located in the tapered region 255 may provide an output flow with improved efficiency compared to a spray device that lacks a pickup tube outlet in a tapered airflow tube. For example, the example electrostatic spray device with the described outlet may provide a higher volume of droplets suspended in the airflow (e.g., within the output flow), allowing a user of the electrostatic spray device to more quickly apply fluid from the reservoir 260.

In addition, the mixing unit 204 may include an air pump 290. FIG. 2 depicts the air pump 290 as being located outside the reservoir 260, but other implementations are possible. The air pump 290 includes a pump intake 292 and a pump output 294. The pump intake 292 is configured to provide air to the air pump 290, such as from ambient air around the mixing unit 204 or from airflow within the airflow tube 250. In some cases, the pump intake 292 may include an air filter, such as (without limitation) a HEPA filter, that is arranged to filter air drawn into the air pump 290. The pump output 294 is configured to provide air from the air pump 290, such as to the reservoir 260. In some implementations, the air pump 290 is configured to modify an air pressure within the reservoir 260. In addition, a modification of air pressure within the reservoir 260 may modify a pressure on a surface of fluid that is contained within the reservoir 260. In some cases, a volume of fluid that is transported via the pickup tube 270 may be adjusted based on a modification of air pressure by the air pump 290. For example, the air pump 290 may increase air pressure within the reservoir 260, such as by compressing air received via the pump intake 292 and providing the compressed air to the reservoir 260 via the pump output 294. Responsive to increased air pressure within the reservoir 260, the pickup tube 270 may receive an increased volume of fluid (e.g., equalizing pressure between air and fluid in the reservoir 260). In addition, the pickup tube 270 may provide the increased volume of fluid to one or more of the airflow tube 250 or the electrostatic mixing chamber 280. In some cases, an electrostatic spray device that includes the mixing unit 204 with the air pump 290 may provide an output flow with improved consistency, such as by providing an adjustable volume of fluid that is included in the output flow.

In some implementations, the volume of fluid in the output flow of an electrostatic spray device may be adjusted based on environmental conditions, such as a level of humidity or a temperature in an area surrounding the electrostatic spray device. In some cases, the volume of fluid in the output flow may be adjusted automatically. For example, a control module included in the example electrostatic spray device (e.g., the control module 105) may determine one or more target characteristics of the output flow based on inputs indicating the environmental conditions of the example electrostatic spray device. Based on the indicated environmental conditions, the control module may determine a target volume of fluid for the output flow. In addition, the control module may generate at least one control signal for the air pump 290. Based on the control signal, the air pump 290 may modify air pressure within the reservoir 260. Responsive to the modified air pressure, the volume of fluid provided to the electrostatic mixing chamber 280 may be adjusted to match the target volume of fluid for the output flow (e.g., determined by the control module).

In some implementations, the pickup tube 270 may include one or more weighted ballast, such as a ballast 275. For example, the ballast 275 may be attached to the pickup tube 270 at (or close to) an intake end of the pickup tube 270. In addition, the ballast 275 may encourage the intake end of the pickup tube 270 to remain at a low point of fluid that is collected within the reservoir 260. For example, if the mixing unit 204 is tipped from side to side, the ballast 275 may encourage the pickup tube 270 to remain within the fluid as the fluid moves around within the reservoir 260. In some cases, an electrostatic spray device that includes the mixing unit 204 with the ballast 275 may have improved efficiency as compared to a spray device that does not include a pickup tube with a weighted ballast. For instance, the example electrostatic spray device may be capable of dispersing a greater portion of the fluid contained in the reservoir 260, reducing waste of the fluid and/or reducing time required to refill the reservoir 260 (e.g., longer periods of use between refills).

In FIG. 2, the reservoir 260 is depicted as having a substantially flat base, but other implementations are possible. For example, an electrostatic spray device may include a reservoir that has one or more sloped surfaces. In some cases, the one or more sloped surfaces collect fluid at a lower end of the reservoir. Configurations of the sloped surfaces may include one or more of a cone-shaped base, at least one sloped side that directs fluid towards a base of the reservoir, a sloped base, or any other suitable configuration of sloped surfaces that is suitable to collect fluid within the reservoir. In some cases, an electrostatic spray device that includes a sloped reservoir (e.g., having at least one sloped surface) may have improved efficiency as compared to a spray device that does not include a sloped reservoir. For instance, the example electrostatic spray device may be capable of dispersing a greater portion of the fluid contained in the sloped reservoir, reducing waste of the fluid and/or reducing time required to refill the sloped reservoir (e.g., longer periods of use between refills).

In some implementations, the mixing unit 204 may include one or more thermal components, such as a thermal regulator 265. A non-limiting example of the thermal regulator 265 may include a thermoelectric cooling/heating device, but other thermal regulation techniques may be used. The thermal regulator 265 may receive power from a power source, such as the battery 130, of an electrostatic spray device that includes the mixing unit 204. The reservoir 260 may include the thermal regulator 265. FIG. 2 depicts the thermal regulator 265 as being attached to an exterior side of the reservoir 260, but other implementations are possible, such as a thermal regulator attached to an interior of the reservoir 260 or to a base of the reservoir 260. The thermal regulator 265 may be configured to regulate a temperature of fluid that is contained in the reservoir 260. For example, the thermal regulator 265 may be capable of heating or cooling fluid. In some cases, thermal regulation of the fluid within the reservoir 260 may improve consistency of output flow from the mixing unit 204. For example, thermal regulation of the fluid may improve consistency of characteristics of the fluid by maintaining fluid temperature within a range that is considered optimal for the type of fluid. In some cases, thermal regulation can improve consistency of fluid characteristics that include one or more of a target viscosity, a target state (e.g., reducing evaporation, reducing sublimation), a target temperature, or any other suitable characteristic of the fluid. In addition, thermal regulation of the fluid can reduce disruptions (e.g., clogging) to the output flow, allowing a user of the electrostatic spray device to apply the output flow more consistently, with fewer interruptions.

In some implementations, the mixing unit 204 may include one or more stirring components, such as an agitator 267. A non-limiting example of the agitator 267 may include a magnetic stirring element, but other agitation techniques may be used. The agitator 267 may receive power from a power source, such as the battery 130, of an electrostatic spray device that includes the mixing unit 204. The agitator 267 may be included within the reservoir 260. In addition, the agitator 267 may be configured to stir or otherwise agitate the fluid that is contained within the reservoir 260. In some cases, agitation of the fluid within the reservoir 260 may improve consistency of output flow from the mixing unit 204. For example, agitation of the fluid may improve consistency of characteristics of the fluid by stirring the fluid while contained in the reservoir 260. In some cases, agitation can improve consistency of fluid characteristics that include one or more of particulate suspension (e.g., solid additives suspended in the fluid), liquid suspension (e.g., mixture of multiple types of fluid), temperature, aeration (e.g., bubbles of gas suspended in the fluid), or any other suitable characteristic of the fluid.

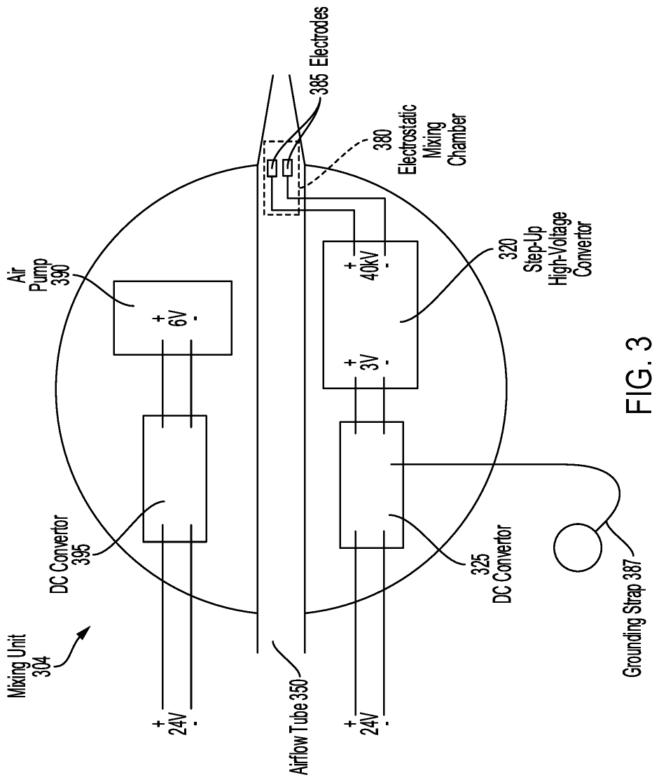

In some implementations, an electrostatic spray device may include one or more electrical components that are configured to provide power at levels suitable for one or more techniques described herein. FIG. 3 is a diagram depicting an example of a mixing unit 304 that may be included in an electrostatic spray device, such as the electrostatic spray device 100. For example, the mixing unit 304 may be attached to the motor unit 102, such as described in regards to FIG. 1. FIG. 3 depicts a top view of a possible configuration of the mixing unit 304, but other configurations are possible. The mixing unit 304 may include an airflow tube 350. In addition, the airflow tube 350 may be configured to connect to a motor unit (e.g., the motor unit 102) such that airflow generated by a fan of the motor unit is directed to the airflow tube 350. In some implementations, the airflow tube 350 includes one or more tapered regions (such as the tapered region 255 as described in regards to FIG. 2).

In some implementations, the mixing unit 304 may include one or more electrical converters configured to modify a level of DC power. The one or more electrical converters may be configured to receive DC power from a power source of an electrostatic spray device that includes the mixing unit 304, such as the battery 130 described in regards to FIG. 1. Although various example electrical components or power characteristics (e.g., voltage levels, current levels) may be described in regards to FIG. 3, these example components and characteristics are understood to be non-limiting, and other suitable components and characteristics may be included in alternative implementations of the techniques described herein.

In FIG. 3, the mixing unit 304 may include a DC converter 395 and an air pump 390. The DC converter 395 may be configured to receive a voltage level of 24V (e.g., from the battery 130). In addition, the DC converter 395 may be configured to provide a modified voltage level to the air pump 390, such as a modified voltage level of 6V. Utilizing the modified voltage level, the air pump 390 may be configured to modify air pressure of a reservoir included in the mixing unit 304 (such as described in regards to FIG. 2). In some cases, the modified voltage provided by the DC converter 395 may be adjustable, such as based on a control signal received from a control module (e.g., the control module 105) of an electrostatic spray device that includes the mixing unit 304. In addition, the air pump 390 may adjust the air pressure of the reservoir, such as based on the modified voltage from the DC converter 395. In some cases, the DC converter 395 may be adjustable based on an input to a flow adjustment switch, such that an adjustable DC output of the DC converter 395 is modifiable responsive to an adjustment to the flow adjustment switch.

In addition, the mixing unit 304 may include a DC converter 325 and a step-up high-voltage converter 320. The DC converter 325 may be configured to receive a voltage level of 24V (e.g., from the battery 130). In addition, the DC converter 325 may be configured to provide a modified voltage level to the high-voltage converter 320, such as a modified voltage level of 3V. Utilizing the modified voltage level, the high-voltage converter 320 may be configured to generate a high-voltage output. For example, the high-voltage converter 320 may produce a high-voltage output in a range between about 40 kV to about 400 kV. In addition, the high-voltage converter 320 may be configured to provide the high-voltage output to an electrostatic field generator, such as a pair of electrodes 385 that are included in an electrostatic mixing chamber 380 of the mixing unit 304. In some cases, the DC converter 325 may be adjustable based on an input to a charge adjustment switch, such that an adjustable DC output of the DC converter 325 is modifiable responsive to an adjustment to the charge adjustment switch.

In some cases, the DC convertor 325 may include, or be configured to connect to, a grounding strap 387. The grounding strap 387 may be electrically connected, or configured to connect, to a ground (e.g., a local ground, a digital ground, a floating ground) of the DC convertor 325. In addition, the grounding strap 387 may be electrically connected, or configured to connect, to a personal grounding interface, such as an ankle strap or wrist strap wearable by a person. In some cases, the grounding strap 387 can be configured to include a person in a ground circuit of the electrodes 385. For instance, a user of the example electrostatic spray device that includes the mixing unit 304 may wear a wrist strap connects electrically to the grounding strap 387, such as via a snap or clip included in the strap 387. In addition, one or more conductive surfaces of the example wrist strap may contact the user's skin. In some cases, an electrical connection between the grounding strap 387 and a personal grounding interface can include the example user in the ground circuit of one or more of the electrodes 385, the DC convertor 325, or one or more additional components of the mixing unit 304. In some cases, an electrical connection among one or more of the grounding strap 387, the DC convertor 325, or a personal grounding interface may include a wired connection or a wireless connection.

FIG. 3 depicts the grounding strap 387 as having an electrical connection to the DC convertor 325, but other implementations are possible. For example, an electrostatic spray device may include a ground shared by multiple components, such as a DC convertor for an air pump and a DC convertor for a step-up high-voltage convertor. In this example, the electrostatic spray device may include a grounding strap (or connection configured for a grounding strap) that is electrically connected to the shared ground. In FIGS. 1 and 3, the grounding straps 187 and 387 are describes in regards to a personal grounding interface worn by a human, but other implementations are possible. For example, an automated or remote-controlled device that is configured to utilize an electrostatic spray device may include a device grounding interface, such as a clamp or ring terminal, that is configured to connect to a grounding strap of the electrostatic spray device. In this example, the device grounding interface may include the automated or remote-controlled device in the ground circuit of electrodes of the electrostatic spray device.

In some implementations, the electrodes 385 may be configured to apply an electrostatic charge to droplets of fluid (such as described in regards to FIG. 2) based on the high-voltage output from the high-voltage converter 320. In addition, a level of the charge applied to the droplets may be modified based on a modification to the high-voltage output. For example, the electrodes 385 may apply a higher level of charge based on a high-voltage output of about 60 kV, as compared to a high-voltage output of about 40 kV. In some cases, the charge applied to the droplets may encourage the droplets to increase a distance between each charged droplet during (or subsequent to) dispersal. In addition, the charged droplets may disperse in a consistent pattern that is based on a level of the charge that is applied to the droplets. For example, droplets that have a higher charge (e.g., a larger absolute value of electrostatic charge) may tend to disperse in a wider pattern as compared to droplets that have a lower charge (e.g., a smaller absolute value of electrostatic charge). The electrodes 385 may be configured to apply a positive electrostatic charge or a negative electrostatic charge to the droplets. In some cases, one or more of the electrodes 385 or the step-up high-voltage convertor 320 may be configured to adjust a polarity of the electrostatic charge. For example, responsive to a control signal (e.g., from the control module 105), one or more of the electrodes 385 or the step-up high-voltage convertor 320 may adjust the polarity of the electrostatic charge from positive (or negative) to negative (or positive). FIG. 3 depicts the electrodes 385 as having a wired connection to the step-up high-voltage convertor 320, but other implementations are possible, such as an electrostatic mixing chamber that includes one or more electrodes having a wireless connection to a voltage convertor or other components of an electrostatic spray device.

In FIG. 3, the electrodes 385 are described as applying an electrostatic charge based on the high-voltage output from the step-up high-voltage convertor 320, but other implementations are possible. For example, an electrostatic spray device may be configured to apply an electrostatic charge via electrostatic induction. For example, an airflow tube in an electrostatic spray device may include one or more interior layers that are configured to rotate within the airflow tube. In some cases, the example interior layers could be arranged to rotate responsive to output from a fan (e.g., airflow within the airflow tube) that is included in the electrostatic spray device. As a non-limiting example, one or more of the interior layers could be arranged as a cylinder, as a disc, or any other arrangement that is suitable to rotate responsive to output from the fan. In addition, the example interior layers may each include one or more conductive regions, such as regions plated with metal foil or other conductive material. Electrostatic charge may be generated responsive to motion of the conductive regions, such as motion of the interior layers rotating within the airflow tube. In some cases, the example electrostatic spray device may include at least one pair of electrodes that are configured to apply, e.g., to fluid droplets, electrostatic charge that is generated via rotation of the conductive regions of the interior layers. In addition, the electrostatic spray device may be configured to provide fluid to an electrostatic mixing chamber that includes the interior layers, such that electrostatic charge generated via rotation of the conductive regions is applied to fluid droplets passing by the interior layers (e.g., during rotation).

In some implementations, the electrodes 385 are configured to modify one or more chemical characteristics of fluid received in the electrostatic mixing chamber 380. For example, the electrodes 385 may be configured to ionize at least a portion of the fluid. Based on the ionization performed by the electrodes 385, fluid that is dispersed by the mixing unit 304 may include a modified quantity of ions (e.g., modified pH level). For example, ionization performed by the electrodes 385 may increase (or decrease) a quantity of acidic ions or a quantity of alkaline ions in the fluid. As an additional example, the electrodes 385 may be configured to ozonate at least a portion of the fluid. Based on the ozonation performed by the electrodes 385, fluid that is dispersed by the mixing unit 304 may include a modified ozone concentration. For example, ozonation performed by the electrodes 385 may increase a quantity of ozone in the fluid. In some cases, an electrostatic spray device that is configured to perform one or more modifications to chemical characteristics of fluid may provide an output flow having a disinfection benefit. For example, ozonation performed by the electrodes 385 may provide an output flow of ozonated fluid from the mixing unit 304. In some cases, ozonated fluid may provide a disinfection benefit.

In some implementations, an electrostatic spray device may include one or more components that are configured to modify an ionization level of at least a portion of fluid that is dispersed by the electrostatic spray device. For instance, the electrostatic spray device may include an extended ionization film arranged within a pickup tube of the electrostatic spray device. In some cases, the extended ionization film may be a semi-enclosed ionization film, such as an extended ionization film that has a first side exposed to fluid in the pickup tube and a second side that is isolated from fluid.

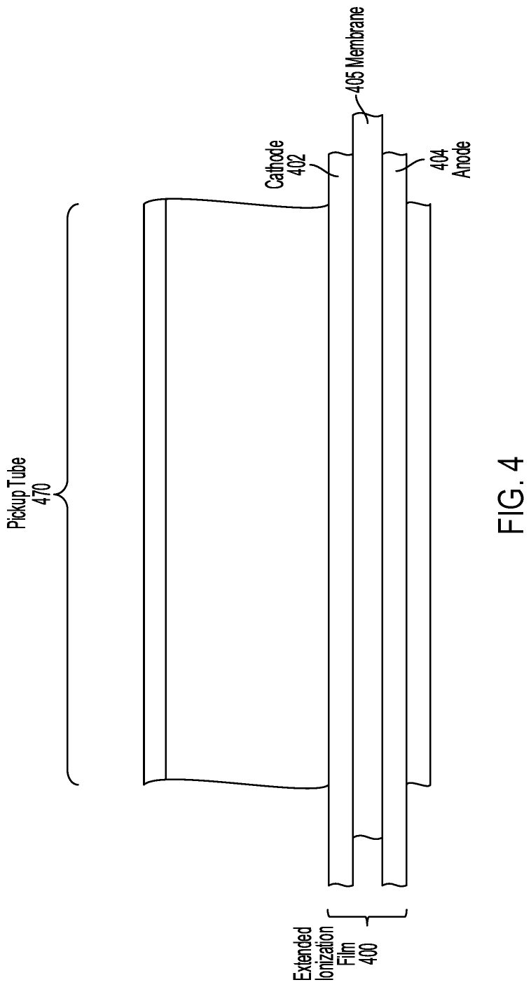

FIG. 4 is a diagram depicting an example region of a pickup tube 470 that may include an extended ionization film 400. In some implementations, one or more of the pickup tube 470 or the extended ionization film 400 may be included in an electrostatic spray device, such as the electrostatic spray device 100. For example, the pickup tube 470 and the extended ionization film 400 may be included in a mixing unit 104, such as described in regards to FIG. 1. FIG. 4 depicts a section view of a possible configuration of the pickup tube 470 and the extended ionization film 400, but other configurations are possible. In some cases, the pickup tube 470 may receive fluid from a reservoir in a mixing unit, such as described in regards to FIG. 1. In addition, the pickup tube 470 may provide the fluid to one or more of an airflow tube or an electrostatic mixing chamber, such as further described in regards to FIG. 1. In some cases, the pickup tube 470 may be comprised of a non-reactive polymer, such as silicone, or any other suitable material that is unlikely to exchange (e.g., receive, provide) ions with the extended ionization film 400 or with fluid that is flowing in the pickup tube 470.

In some implementations, the extended ionization film 400 may include one or more of a cathode 402, an anode 404, or a membrane 405. The cathode 402 may be arranged to maintain contact with a first surface of the membrane 405, and the anode 404 may be arranged to maintain contact with a second surface of the membrane 405. In some cases, the membrane 405 may be configured to facilitate movement of ions through the membrane 405 while preventing movement of additional particles (e.g., atoms, chemical components) through the membrane 405. For example, the membrane 405 may be a proton-exchange membrane, a polymer-electrolyte membrane, or any suitable type of membrane that is configured to selectively facilitate movement of ions. In some cases, one or more of the cathode 402 or the anode 404 may comprise conductive metals (e.g., capable of conducting electrons) and/or reactive metals (e.g., capable of providing and/or receiving electrons).

In some cases, the extended ionization film 400 may have an extended length that matches (or nearly matches) a length of the pickup tube 470. For example, the extended ionization film 400 may have an extended length that is equivalent to about 85% or more of the length of the pickup tube 470. In some cases, the extended length of the extended ionization film 400 may provide improved ionization of fluid that is moving through the pickup tube 470. For example, the fluid in the pickup tube 470 may exchange (e.g., receive, provide) ions with the extended ionization film 400 for most of the extended length of the film 400. In some cases, an electrostatic spray device that includes the extended ionization film 400 in the pickup tube 470 may provide an output flow having an ionization benefit. For example, fluid that has an increased quantity of protons (e.g., acidic fluid) may provide a disinfection benefit.

In addition, the extended ionization film 400 may be a semi-enclosed ionization film. For example, the semi-enclosed extended ionization film 400 may be arranged such that a first surface of the film 400 maintains contact with fluid that is flowing through the interior of the pickup tube 470. In addition, the semi-enclosed extended ionization film 400 may be arranged such that a second surface of the film 400 maintains contact with a surface of the pickup tube 470. In FIG. 4, the semi-enclosed extended ionization film 400 may be arranged such that a first surface of the cathode 402 maintains contact with fluid in the pickup tube 470, and a second surface of the anode 404 maintains contact with the surface of the pickup tube 470. In one or more additional implementations, the semi-enclosed extended ionization film 400 may be arranged such that the first surface of the cathode 402 maintains contact with the surface of a pickup tube and the second surface of the anode 404 maintains contact with fluid in the pickup tube.

In some cases, a semi-enclosed arrangement of the extended ionization film 400 may prevent contact between the fluid flowing through the interior of the pickup tube 470 and the second surface of the film 400. For example, if the cathode 402 maintains contact with fluid in the pickup tube 470, the anode 404 may be isolated from the fluid based on the semi-enclosed arrangement of the extended ionization film 400. In some implementations, if the anode 404 maintains contact with fluid in the pickup tube 470, the cathode 402 may be isolated from the fluid based on the semi-enclosed arrangement of the extended ionization film 400. In some cases, an electrostatic spray device that includes the semi-enclosed extended ionization film 400 may ionize fluid in the pickup tube 470 with improved efficiency. For example, the semi-enclosed extended ionization film 400 may reduce re-exchange of ions across the membrane 405.

FIG. 4 depicts an implementation in which the anode 404 is in contact with a surface of the pickup tube 470, but other implementations are possible. For example, a semi-enclosed extended ionization film may include an additional material that is isolated from fluid in a pickup tube. The additional material may maintain contact with an anode of the example film (or cathode, depending on orientation of the example film). In some cases, the additional material may provide ions that are capable of moving through a membrane of the example film, such that the example same the enclosed extended ionization film provides ions from the additional material to fluid in the pickup tube.

FIG. 4 depicts an example of a semi-enclosed extended ionization film that is arranged with respect to a pickup tube in an electrostatic spray device, but other implementations are possible. For example, one or more of an extended ionization film, a semi-enclosed ionization film, or a semi-enclosed extended ionization film may be included in (or configured to be used with) other types of devices, such as devices other than electrostatic spray devices.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. An electrostatic spray device comprising:
a fan;
a motor that is configured to drive the fan;
a first direct current (“DC”) convertor having a first adjustable DC output;
an electrostatic mixing chamber that is configured to receive a) an airflow from the fan, and b) a flow of fluid from a reservoir;
an electrode pair that is included in the electrostatic mixing chamber,
wherein the electrode pair is configured to apply an electrostatic charge to droplets of the fluid that are suspended in the airflow,
wherein a voltage level of the electrostatic charge is adjustable responsive to a first modification of the first adjustable DC output; and
a second DC convertor having a second adjustable DC output,
wherein a flow volume of the flow of fluid from the reservoir is adjustable responsive to a second modification of the second adjustable DC output.

2. The electrostatic spray device of claim 1, further comprising an air pump that is configured to apply air pressure to a surface of the fluid contained within the reservoir,
wherein, responsive to the second modification of the second adjustable DC output, the air pump adjusts a pressure level of the air pressure within the reservoir,
wherein the modified flow volume of the flow of fluid from the reservoir is responsive to the adjusted pressure level of the air pressure.

3. The electrostatic spray device of claim 1, further comprising:
a charge adjustment switch that is coupled to the first DC convertor, wherein the first adjustable DC output is modified responsive to an adjustment to the charge adjustment switch; and
a flow adjustment switch that is coupled to the second DC convertor, wherein the second adjustable DC output is modified responsive to an adjustment to the flow adjustment switch.

4. The electrostatic spray device of claim 1, further comprising a pulse width modulation (“PWM”) switch that is coupled to the motor,
wherein, responsive to an additional modification of the PWM switch, the motor adjusts a speed of the fan,
wherein an air volume of the airflow from the fan is adjustable responsive to the adjusted speed of the fan.

5. The electrostatic spray device of claim 1, further comprising a control unit, wherein the control unit is configured for:
determining a target level of one or more of: the voltage level of the electrostatic charge, the flow volume of the flow of fluid, or the airflow from the fan; and
modifying, responsive to determining the target level, one or more of: the first adjustable DC output, the second adjustable DC output, or a speed of the fan.

6. The electrostatic spray device of claim 1, wherein the motor is a brushless motor.

7. The electrostatic spray device of claim 1, wherein the electrostatic mixing chamber has one or more interior surfaces forming a tapered region, the tapered region having a) an inlet that is capable of receiving the airflow and b) an outlet that is capable of releasing an output flow that includes the electrostatically charged droplets that are suspended in the airflow,
wherein the inlet has a wider dimension than the outlet, such that a velocity of the electrostatically charged droplets is increased via a transition of the electrostatically charged droplets from the inlet of the taper region to the outlet of the tapered region.

8. The electrostatic spray device of claim 1, wherein the reservoir includes one or more of:
a sloped surface that is configured to collect the fluid while the electrostatic spray device is in a substantially upright position, or
a pickup tube that is configured to provide the fluid to the electrostatic mixing chamber, the pickup tube having a) a first end that is connected to the electrostatic mixing chamber and b) a second end having a weighted ballast, such that the second end is encouraged, by the weighted ballast, to remain in the fluid of the reservoir.

9. The electrostatic spray device of claim 1, further comprising an indicator that indicates a presence of the electrostatic charge, the indicator being one or more of: a neon-gas lighting element, a light-emitting diode, or an audible signal.

10. The electrostatic spray device of claim 1, further comprising an air filter arranged to filter the airflow prior to the airflow being received by the electrostatic mixing chamber.

11. The electrostatic spray device of claim 1, further comprising a grounding strap having a first electrical connection to a ground of the first DC convertor and a second electrical connection to a personal grounding interface,
wherein a user of the personal grounding interface is included in a ground circuit of the electrode pair.

12. An electrostatic mixing chamber comprising:
an electrode pair that is included in the electrostatic mixing chamber,
wherein the electrode pair is configured to apply an electrostatic charge to droplets of fluid that are suspended in an airflow received by the electrostatic mixing chamber,
wherein a voltage level of the electrostatic charge is adjustable based on a first adjustable DC output; and
wherein a flow volume of the fluid from is adjustable based on a second adjustable DC output.

13. The electrostatic mixing chamber of claim 12, further comprising:
one or more interior surfaces forming a tapered region, the tapered region having a) an inlet that is capable of receiving the airflow and b) an outlet that is capable of releasing an output flow that includes the electrostatically charged droplets that are suspended in the airflow,
wherein the inlet has a wider dimension than the outlet, such that a velocity of the electrostatically charged droplets is increased via a transition of the electrostatically charged droplets from the inlet of the taper region to the outlet of the tapered region.

14. The electrostatic mixing chamber of claim 12, further comprising a control unit, wherein the control unit is configured for:
determining a target level of one or more of: the voltage level of the electrostatic charge, or the flow volume of the fluid; and
modifying, responsive to determining the target level, one or more of: the first adjustable DC output, or the second adjustable DC output.

15. A method of dispersing an electrostatic spray of a liquid, the method comprising:
generating, by a control unit included in an electrostatic spray device, a first control signal for a first direct current (“DC”) convertor having a first adjustable DC output;
modifying, via the first control signal, a voltage level of an electrode pair that is included in the electrostatic spray device wherein the electrode pair is configured to apply an electrostatic charge to droplets of fluid that are suspended in an airflow of the electrostatic spray device;
generating, by the control unit, a second control signal for a second DC convertor having a second adjustable DC output; and
modifying, via the second control signal, a flow volume of a flow of fluid from a reservoir of the electrostatic spray device.

16. The method of claim 15, further comprising:
determining, by the control unit, a target characteristic of an output flow from the electrostatic spray device; and
generating the second control signal based on the determined target characteristic.

17. The method of claim 15, further comprising:
determining a target level of one or more of: the voltage level or the flow volume of the flow of fluid;
responsive to determining the target level, generating an additional control signal; and
modifying, responsive to determining the target level, one or more of: the first adjustable DC output or the second adjustable DC output.

18. The method of claim 15, further comprising:
receiving, by the control unit included in the electrostatic spray device, an input;
wherein one or more of the first control signal or the second control signal are generated responsive to receiving the input.

19. The method of claim 15, wherein:
the second adjustable DC output is received by an air pump in the electrostatic spray device, the air pump being configured to apply air pressure to a surface of the fluid contained within the reservoir,
responsive to the second control signal, the air pump adjusts a pressure level of the air pressure within the reservoir,
modifying the flow volume of the flow of fluid from the reservoir is responsive to the adjusted pressure level of the air pressure.

20. The method of claim 15, wherein:
the first adjustable DC output is received by a step-up high-voltage converter, the step-up high-voltage converter being configured to provide a high-voltage output to the electrode pair,
responsive to the first control signal, the step-up high-voltage converter modifies the high-voltage output,
modifying the voltage level of the electrode pair is responsive to the modified the high-voltage output.
